(19) United States
(12) Patent Application Publication
(10) Pub. No.: US 2009/0026030 A1
(43) Pub. Date: Jan. 29, 2009

(54) Shock absorber staged valving system

(75) Inventors: Simon Anne de Molina, Marche-Les-Dames (BE); Jean-Marie Tuts, Wellen (BE)

Correspondence Address: HARNESS, DICKEY & PIERCE, P.L.C., P.O. BOX 828, BLOOMFIELD HILLS, MI, 48303, US

(73) Assignee: Tenneco Automotive Operating Company Inc., Lake Forest, IL (US)

(21) Appl. No.: 12/228,678

(22) Filed: Aug. 13, 2008

Related U.S. Application Data
(63) Continuation of application No. 10/662,662, filed on Sep. 15, 2003, now abandoned.

(51) Int. Cl. F16F 9/34; F16F 9/00

(52) U.S. Cl. 188/322.13; 188/322.22

(57) ABSTRACT

A shock absorber piston assembly includes a shock absorber piston having a first face and an opposed second face. A plurality of fluid passages extend between the first face and the second face. A plurality of valves attach to the piston, including: at least two rebound valves, each connectable to one of the fluid passages, and at least two compression valves, each connectable to one of the fluid passages. Each of the valves actuates at one of a plurality of valve opening pressures individually adjustable for each valve. The shock absorber piston assembly can be used in either a monotube or a dual tube shock absorber.

### FIELD OF THE INVENTION

The present invention relates generally to automotive dampers or shock absorbers, having valve assemblies for damping. More particularly, the present invention relates to a shock absorber valve assembly which allows staged opening of the valves to control shock absorber damping.

### BACKGROUND OF THE INVENTION

Shock absorbers are used in conjunction with automotive suspension systems to absorb unwanted vibrations which occur during driving. Shock absorbers are generally connected between the sprung portion (body) and the unsprung portion (wheels) of the automobile. A piston is located within a working chamber defined by a pressure tube of the shock absorber, with the piston being connected to the sprung portion of the automobile through a piston rod. The pressure tube is connected to the unsprung portion of the vehicle by one of the methods known in the art. Because the piston is able, through valving, to limit the flow of damping fluid between opposite sides of the piston when the shock absorber is compressed or extended, the shock absorber is able to produce a damping force which damps the unwanted vibration which would otherwise be transmitted from the unsprung portion to the sprung portion of the automobile.

In a dual tube shock absorber, a fluid reservoir is defined between the pressure tube and a reserve tube. Separate piston valving and base valving are used. A base valve is typically located between the lower portion of the working chamber (the area below the piston) and the reservoir, to limit the flow of fluid between the lower working chamber and the reservoir. The greater degree to which the flow of fluid within the shock absorber is restricted by the piston valving and the base valving, the greater the damping forces which are generated by the shock absorber. Thus, a highly restricted flow of fluid would produce a firm ride while a less restricted flow of fluid would produce a soft ride.

Shock absorbers have been developed to provide different damping characteristics depending upon the speed or acceleration of the piston within the pressure tube. Because of the exponential relation between the pressure drop and flow rate, it is difficult to obtain a damping force at relatively low piston velocities, particularly at velocities near zero. Low speed damping force is important to vehicle handling since most vehicle handling events are controlled by low speed vehicle body velocities. It is also important to control damping force over the broad range of pressures generated across the piston as the piston velocity increases.

Various prior art systems for tuning shock absorbers during low speed movement of the piston use a fixed low speed bleed orifice to provide a bleed passage which is always open across the piston. This bleed orifice can be created by utilizing orifice notches positioned either on the flexible disc adjacent to the sealing land or by utilizing orifice notches directly in the sealing land itself. A limitation of these designs is that because the orifice is constant in cross-sectional area, the created damping force is not a function of the internal pressure of the shock absorber. In order to obtain low speed control utilizing these open orifice notches, the orifice notches have to be small enough to create a restriction at relatively low velocities. When this is accomplished, the low speed fluid circuit of the valving system will only operate over a very small range in velocity. Therefore, the secondary or high speed stage valving is activated at a lower velocity that is desired. Activation of the secondary valving at relatively low velocities creates harshness because the shape of the fixed orifice bleed circuit force velocity characteristic is totally different than the shape of the high speed circuit.

### SUMMARY OF THE INVENTION

The present invention provides the art with a shock absorber piston assembly that includes a shock absorber piston having a first face and an opposed second face. A plurality of fluid passages extend between the first face and the second face. A plurality of valves attach to the piston, including: at least two rebound valves, each connectable to one of the fluid passages, and at least two compression valves, each connectable to one of the fluid passages. Each of the valves actuates at a valve opening pressure individually adjustable for each valve.

In another embodiment, the invention provides the art with a shock absorber that includes a tube forming a pressure chamber and operably containing a fluid. A piston assembly is slidably positionable within the tube. The piston divides the pressure chamber into a first working chamber and a second working chamber. The piston assembly includes: (i) a piston defining a plurality of fluid passages extending between the first working chamber and the second working chamber; (ii) at least two rebound valves attached to the piston for controlling a flow of the fluid from the first working chamber to the second working chamber; and (iii) at least two compression valves attached to the piston for controlling a flow of the fluid from the second working chamber to the first working chamber. Each of the rebound valves and the compression valves are individually preset to open at different pressures of the fluid such that the rebound valves open in a rebound valve successive order and the compression valves open in a compression valve successive order.

In yet another embodiment, the invention provides the art with a shock absorber that includes a piston tube. A piston assembly is slidably disposed within the piston tube operably dividing the piston tube into a first working chamber and a second working chamber. The piston assembly includes: a shock absorber piston having a first face and an opposed second face; a plurality of fluid passages extending between the first face and the second face; and a plurality of valves externally attached to the piston. The valves include: at least two rebound valves, each connectable to at least one of the fluid passages; and at least two compression valves, each connectable to at least one of the fluid passages. A piston rod fastenably attaches to the piston assembly.

In still another embodiment, a method to dampen an automobile vehicle ride deflection is provided, the vehicle having at least one shock absorber, each shock absorber having a piston with a first face and a second face and a plurality of through fluid passages. The method comprises: orienting at least two rebound valves with select fluid passages of the piston to open toward the first face of the piston; arranging at least two compression valves with select fluid passages of the piston to open toward the second face of the piston; adjusting each of the rebound valves to open sequentially upon exposure to a predetermined set of increasing first face fluid pressures; and preconditioning each of the compression valves to open sequentially upon exposure to a predetermined set of increasing second face fluid pressures.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a shock absorber tube having a shock absorber assembly of the present invention;

FIG. 2 is a partial cross-sectional view taken through Section 2 of FIG. 1;

FIG. 3 is a partially exploded sectional view taken from FIG. 2;

FIG. 4 is a plan view of a bleed disc of the present invention;

FIG. 5 is a partial sectional view similar to FIG. 2 showing a partial opening of the rebound valve of the present invention;

FIG. 6 is a partial section view identifying an alternative embodiment of a shock absorber assembly of the present invention;

FIG. 7 is a partial cross-sectional view of another embodiment of a shock absorber assembly valve of the present invention;

FIG. 8 is a flow diagram of the steps to dampen an automobile vehicle ride deflection; and

FIG. 9 is a side elevational view of a shock absorber incorporating a shock absorber assembly of the present invention.

### DETAILED DESCRIPTION OF THE PREFERRED EMBODIMENTS

The following description of the preferred embodiments is merely exemplary in nature and is in no way intended to limit the invention, its application, or uses.

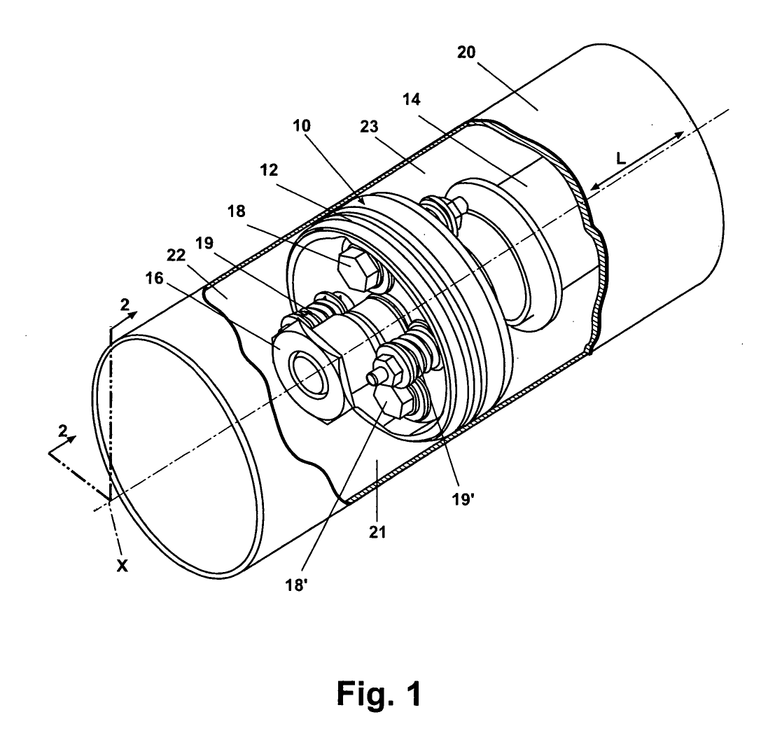

Referring to FIG. 1, and according to a preferred embodiment of the present invention, a shock absorber assembly 10 of the present invention includes a piston 12 connected to a rod 14 using a nut 16. An exemplary pair of rebound valves 18, 18′ and an exemplary pair of compression valves 19, 19′ are connected to piston 12. Rebound valves 18, 18′ and compression valves 19, 19′ are arranged to open toward opposed faces of piston 12. Piston 12 is typically arranged to slide within a tube 20 along a longitudinal axis “X” in the direction of arrows “L”. Tube 20 is enclosed on opposed ends forming a fluid chamber 21. Piston 12 divides tube 20 into a first working chamber 22 and a second working chamber 23. Fluid within fluid chamber 21 is directed between first working chamber 22 and second working chamber 23 by alternately opening rebound valves 18, 18′ or compression valves 19, 19′. Motion of piston 12 within tube 20 creates a higher fluid pressure on one side of piston 12 which is relieved by flow of the fluid through either rebound valves 18, 18′ or compression valves 19, 19′.

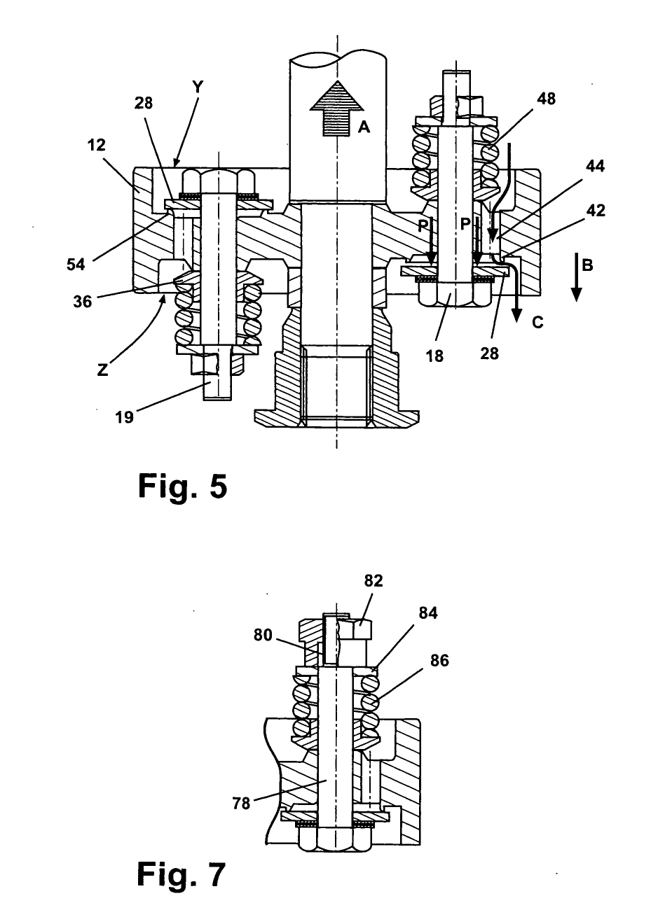

For a shock absorber assembly 10 of the present invention, at least two rebound valves and at least two compression valves are required. The valves are individually adjusted such that a different valve opening pressure “P” (shown and described in reference to FIG. 5) for each valve is preloaded, by either adjusting the spring of each valve or by selectively choosing springs with differing spring constants. This permits individual ones of the rebound valves or the compression valves to open in a successive order. For instance, referring to FIG. 1, in an exemplary successive order, compression valve 19 opens first (at a valve opening pressure P₁), and compression valve 19′ opens second (at a valve opening pressure P₂). By delaying opening of the second (or more) valve, a desired damping characteristic can be achieved having different blow off levels with different corresponding high speed restrictions.

Rebound valves 18, 18′ are shown arranged 180° apart from each other in FIG. 1. Similarly, compression valves 19, 19′ are also shown arranged 180° apart from each other in FIG. 1. This arrangement of rebound valves 18, 18′ and compression valves 19, 19′ is exemplary. The valves can be arranged in any orientation including adjacent to each other or opposed to each other as shown. The invention is also not limited to a minimum of two each of the rebound valves 18, 18′ and compression valves 19, 19′. Additional rebound valves (not shown) and compression valves (not shown) can also be used.

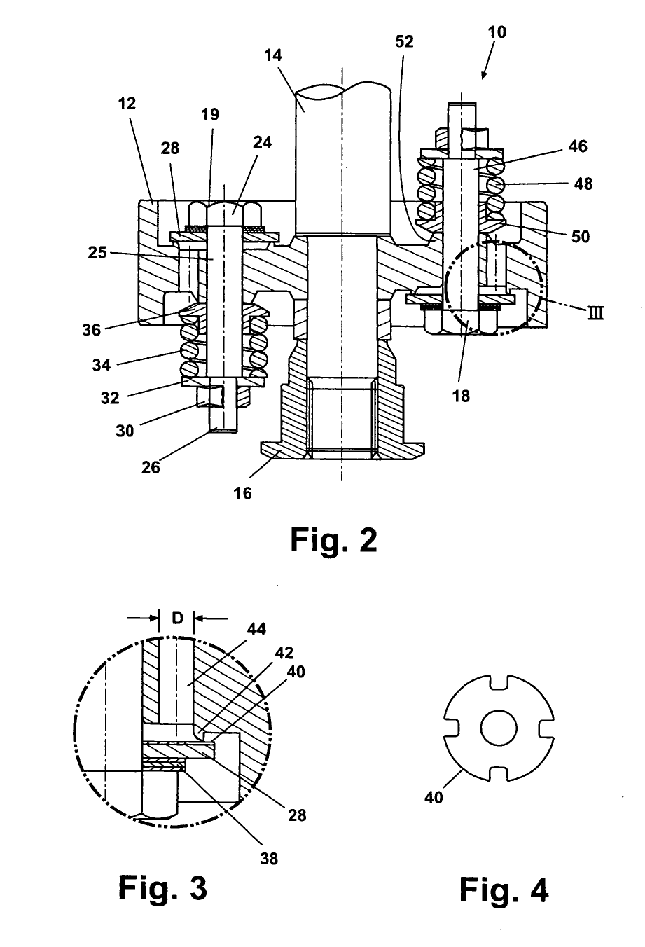

As best seen in FIG. 2, nut 16 is fastenably engaged to rod 14, to non-rotatably engage rod 14 with piston 12. Compression valve 19 includes a tool engagement end 24, a pin 25, and a threaded end 26. A valve plate 28 is disposed adjacent to tool engagement end 24. The function and operation of valve plate 28 will be further described in reference to FIG. 3. A nut 30 engaged on threaded end 26 of compression valve 19 abuts a washer 32 on a shoulder of pin 25. Nut 30 and washer 32 retain a spring 34 positioned between washer 32 and a spring retainer 36. In the valve closed position shown, spring retainer 36 of compression valve 19 is in physical contact with piston 12. A spring force of spring 34 also retains valve plate 28 in contact with piston 12 in the valve closed position.

As best seen in FIG. 3, valve plate 28 of rebound valve 18 supports a plurality of shim discs 38 (further described below) and a bleed disc 40 on opposite faces of valve plate 28. In the valve closed position shown, valve plate 28 contacts a flow port seal 42 formed as an extended land from piston 12. In the valve closed position shown, fluid in one or more orifices 44 is generally prevented from flowing past valve plate 28, except as desired through the bleed disc 40. Each orifice 44 includes a diameter “D” which can be sized depending upon the desired flow rate of fluid through orifice 44, the type of fluid in the tube 20 (shown in FIG. 1), and the viscosity of the fluid. In addition, the number of orifices 44 can be changed depending on the desired flow rate of fluid.

The purpose of shim discs 38 is to permit fine tuning of the preload on the spring of any of the rebound or compression valves. Shim discs 38 can be installed as single discs or as a plurality of discs depending upon the preload requirement for the spring. Shim discs 38 are generally installed at the time of installation of the rebound or compression valves.

Referring back to FIG. 2, rebound valve 18 includes a pin 46, a spring 48 and a spring retainer 50. Spring retainer 50 contacts a land 52 formed as a raised surface on piston 12. Land 52 is commonly used for both rebound valves and compression valves on the spring positioned face(s) of piston 12. Similar to spring 34, spring 48 holds rebound valve 18 in the valve closed position shown until a valve opening pressure “P”, greater than the preload on spring 34, unseats rebound valve 18.

Referring now to FIG. 4, the exemplary bleed disc 40 is provided with a plurality of notches which permit a limited volume of fluid flow through orifice 44 for low velocity, low amplitude displacement of piston 12. This low amplitude displacement normally occurs when the vehicle is traveling on a smooth surface, providing limited displacement of the shock absorber assembly 10. In a preferable application, only a single bleed disc 40 is installed in a piston 12, normally on a select one of either the rebound valves or the compression valves. If desired or necessary, however, multiple bleed discs 40 can be installed in more than one of the rebound valves and/or the compression valves.

As best seen in FIG. 5, compression valve 19 is shown in a valve closed position and rebound valve 18 is shown in a valve open position. In the valve closed position shown for compression valve 19, valve plate 28 is in physical contact with a flow port seal 54, and spring retainer 36 is in contact with an extending land (similar to land 52 described in reference to FIG. 2) on an opposed face of piston 12. When piston 12 travels in the disc/rod travel direction “A”, fluid pressure increases in second working chamber 23 and on a first or “Y” face of piston 12. This increase in pressure occurs until the valve opening pressure, indicated by arrows “P” is reached. Once valve opening pressure “P” is reached, fluid pressure operates against valve plate 28 to compress a spring 48 which unseats valve plate 28 from flow port seal 42. Rebound valve 18 repositions from the increasing fluid pressure acting in the valve opening direction “B” to allow flow of fluid between the second working chamber 23 and the “Y” or first face of piston 12, through orifice 44, towards the first working chamber 22 and a “Z” or second face of piston 12, in a first fluid flow path direction “C” as shown.

If the piston 12 travel direction is reversed from the travel direction “A”, increased fluid pressure in the first working chamber 22 and on the “Z” face of piston 12 holds rebound valve 18 in a valve closed position and valve opening pressure “P” (predetermined) acting on valve plate 28 of compression valve 19 moves compression valve 19 to a valve open position in the same manner as described for rebound valve 18 of FIG. 5. Fluid flow through the orifice or orifices associated with compression valve 19 is in a second fluid flow path direction (not shown) opposite to fluid flow path direction “C”, directing fluid flow from the first working chamber 22 and the “Z” face toward the second working chamber 23 and the “Y” face of piston 12.

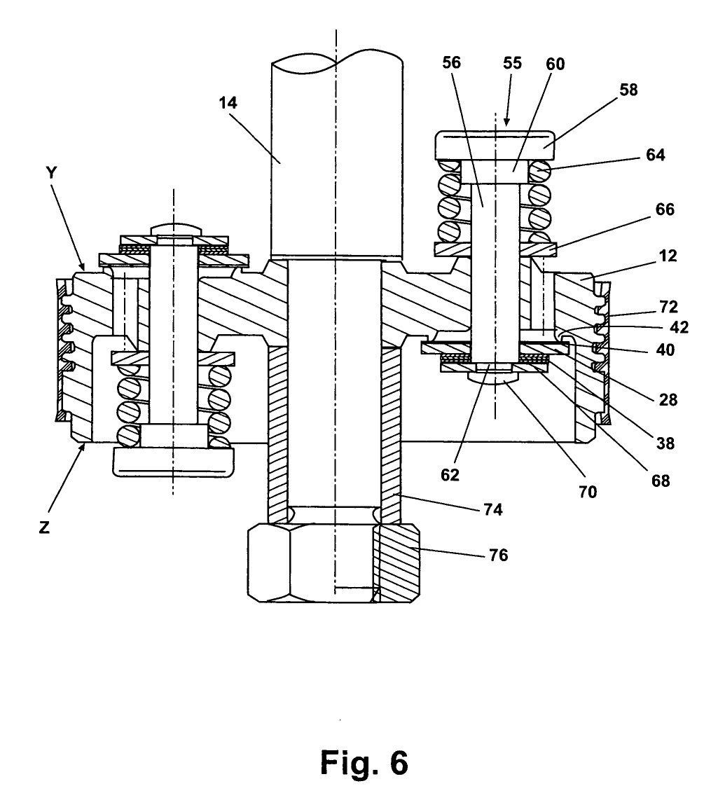

Referring next to FIG. 6, another embodiment of a shock absorber assembly of the present invention is shown, having valve fastener ends reversed. A rebound valve 55 includes a pin 56, having a capped end 58, an integral sleeve 60, and a shoulder end 62. Rebound valve 55 is fastened at an opposite end from that shown for rebound valve 18 of FIG. 5, that is (i.e.) a spring 64 is not removable from the first or “Y” side of piston 12. Spring 64 engages over integral sleeve 60 on a first end and is retained by spring support 66 on a second end. Similar to the arrangement shown in FIG. 5, bleed disc 40 is positioned adjacent to flow port seal 42, and valve plate 28 is positioned adjacent to bleed disc 40. In this embodiment, shim discs 38 (if used) are positioned adjacent the shoulder end 62 of rebound valve 55. Shim discs 38 are held in position by a support washer 68. An end of pin 56 opposite to capped end 58 is deformed to form a retaining head 70 to retain the support washer 68, shim discs 38, valve plate 28 and bleed disc 40, respectively. The advantage of the design shown in FIG. 6 is that shim discs 38 can be installed at the final installation phase of either a rebound or a compression valve. The retaining head 70 is formed to complete installation of the valve. This allows a fine tuning of the preload spring force of spring 64 to permit a rebound valve or a compression valve opening pressure to be finely adjusted without removing valve components to add or remove shim discs 38.

FIG. 6 also shows an alternate design for attaching piston 12 to rod 14. A spacer sleeve 74 is provided between a nut 76 and piston 12 to provide clearance for the rebound valve and the compression valve respectively. Similar to the arrangement shown and described in reference to FIG. 2, nut 76 and spacer sleeve 74 nonrotatably fasten piston 12 to rod 14. FIG. 6 also shows an exemplary embodiment of a band/seal 72 positioned at a perimeter of piston 12. Band/seal 72 provides a fluid seal between piston 12 and tube 20 (shown and described in reference to FIG. 1) directing fluid flow toward only the orifice of either the rebound valves or the compression valves.

Referring next to FIG. 7, another embodiment for a valve design of the present invention is shown. A pin 78 includes a threaded end 80. A tensioning nut 82 is threadably engaged with threaded end 80 and contacts a washer 84 to compress a spring 86. The substantially hollow design of tensioning nut 82 permits tensioning nut 82 to extend over the diameter of pin 78 allowing tensioning nut 82 to compress or decompress spring 86 as required. Tensioning nut 82 therefore permits controlling a preload of spring 86. For fine preload adjustment during assembly, one or more shim discs 38 (described in reference to FIG. 3) can also be used with the embodiment shown in FIG. 7.

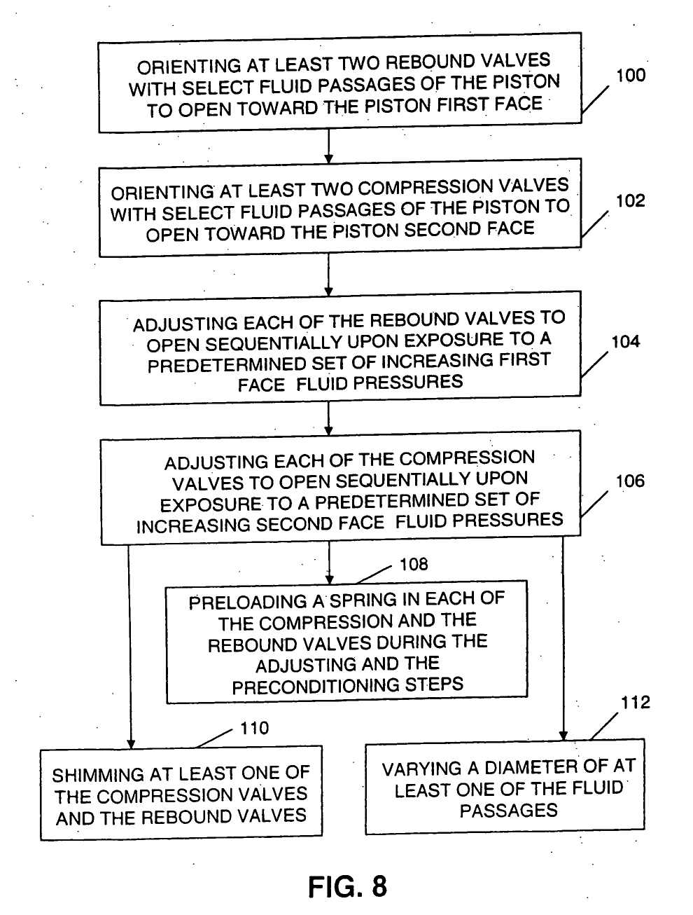

Referring to FIG. 8, the steps to dampen an automobile vehicle deflection are described. In step 100, at least two rebound valves are oriented with select fluid passages of the piston to open toward the piston first face. In step 102, at least two compression valves are oriented with select fluid passages of the piston to open toward the piston second face. In step 104, each of the rebound valves are adjusted to open sequentially upon exposure to increasing first face fluid pressure. In step 106, each of the compression valves are adjusted to open sequentially upon exposure to increasing second face fluid pressure. In a parallel step 108, a spring in each of the compression and the rebound valves is preloaded. In another parallel step 110, at least one of the compression valves and the rebound valves is shimmed. In still another parallel step 112, a diameter of at least one of the fluid passages is varied.

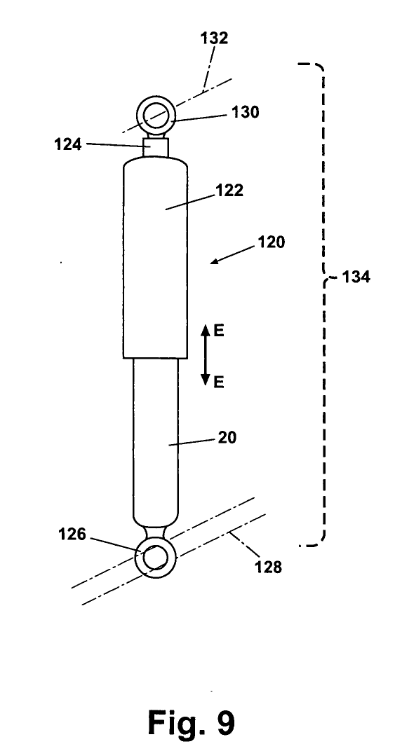

As shown in FIG. 9, a shock absorber 120 includes a tube 20 enclosing shock absorber assembly 10 (shown in reference to FIG. 1). Tube 20 is disposed within a tubular end 122, and shock absorber assembly 10 is displaceable within tube 20 in the direction of displacement arrows “E”. A freely extending end 124 of piston rod 14 extends beyond tubular end 122. A first end fitting 126 is secured to a lower end of tube 20 for operatively securing the shock absorber 120 to an axle assembly 128 of an automobile vehicle 134 in a conventional manner. A second end fitting 130 is secured to the freely extending end 124 of piston rod 14. Second end fitting 130 operatively secures shock absorber 120 to an automobile vehicle body 132, also in a conventional manner.

Shock absorber 120 is configurable as a monotube shock absorber known in the art and as generally shown in FIG. 1, or is alternately configurable as a dual tube shock absorber (not shown) having shock absorber assembly 10 positioned within an inner pressure tube, but with rebound valves 18 from shock absorber assembly 10 associated with a rebound stroke relocated to an outer tube seal, isolating an outer pressure tube as known in the art.

In addition to controlling valve opening pressure “P” for the successive operation of the two or more rebound valves and/or compression valves of the present invention, the diameter of the orifice for each piston can also be varied to allow the shock absorber assembly of the present invention to further operate at different speeds and/or for different fluid types. The spring rate or spring constant “K” for each of the springs can also be varied to predetermine a preload difference between individual ones of the rebound valve springs or of the compression valve springs. The valve opening pressure “P” (shown in FIG. 5 as arrows P), is also adjustable between the groups designated as the rebound valves and the compression valves. Each valve of the rebound valve type and each valve of the compression valve type can therefore open at a different pressure.

Materials for a shock absorber assembly of the present invention are known. Pistons are typically cast, sintered, metallic material. The rod and nut are also typically formed of metallic materials. Valve materials are also typically metallic including steel materials. The springs are typically formed of a spring steel, and the spring retainers 36, valve plates 28, bleed discs 40, and support washers are also formed of a spring steel or similar hardened steel material. A shock absorber assembly of the present invention, however, is not limited to the materials identified herein. Alternate materials including composite materials and polymeric materials can also be selectively substituted for individual parts of the shock absorber assembly of the present invention without departing from the gist of the present invention. The fluid used in conjunction with a shock absorber assembly of the present invention can include gases or liquids known in the art. Exemplary fluids in liquid form include hydrocarbon based liquids such as oil or hydraulic fluid. The springs described herein are preferably coiled springs, but springs of alternate designs can also be used, including leaf springs, stacked plate springs, etc.

While the above detailed description describes the preferred embodiments of the present invention, it should be understood that the present invention is susceptible to modification, variation and alteration without deviating from the scope and fair meaning of the subjoined claims.

What is claimed is:

1. A shock absorber comprising:
a pressure tube defining a working chamber;
a piston body disposed within said pressure tube, said piston body dividing said working chamber into an upper working chamber and a lower working chamber;
first means for allowing fluid flow from said upper working chamber directly to said lower working chamber through said piston body above a first specified fluid pressure within said upper working chamber, said first means prohibiting fluid flow from said upper working chamber to said lower working chamber below said first specified fluid pressure within said upper working chamber;
second means for allowing fluid flow from said upper working chamber directly to said lower working chamber through said piston body above a second specified fluid pressure within said upper working chamber, said second means prohibiting fluid flow from said upper working chamber to said lower working chamber below said second specified fluid pressure within said upper working chamber, said second specified fluid pressure being greater than said first specified fluid pressure;

2. The shock absorber according to claim 1 further comprising third means for allowing fluid flow from said lower working chamber directly to said upper working chamber through said piston body above a third specified fluid pressure within said lower working chamber, said first means prohibiting fluid flow from said lower working chamber to said upper working chamber below said third specified fluid pressure within said lower working chamber;
fourth means for allowing fluid flow from said lower working chamber directly to said upper working chamber through said piston body above a fourth specified fluid pressure within said lower working chamber, said fourth means prohibiting fluid flow from said lower working chamber to said upper working chamber below said fourth specified fluid pressure within said lower working chamber, said fourth specified fluid pressure being greater than said third specified fluid pressure.

3. The shock absorber according to claim 2 wherein said third and fourth means allow fluid flow above said fourth specified fluid pressure.

4. The shock absorber according to claim 3 wherein said first and second means allow fluid flow above said second specified fluid pressure.

5. The shock absorber according to claim 2 wherein said third and fourth means comprise an adjustable valve.

6. The shock absorber according to claim 5 wherein said first and second means comprises an adjustable valve.

7. Claim 4 depends on claim 1.

8. Claim 6 depends on claim 1.

9. A shock absorber comprising:
a tube forming a pressure chamber;
a piston body slidably disposed within the tube, the piston body dividing the pressure chamber into a first working chamber and a second working chamber;
a first single direction valve attached to the piston body, the first single direction valve actuating at a first specified fluid pressure to allow fluid flow from the first working chamber directly to the second working chamber when fluid pressure in the first working chamber is above the first specified fluid pressure;
a second single direction valve attached to the piston body, the second single direction valve actuating at a second specified fluid pressure to allow fluid flow from the first working chamber directly to the second working chamber when fluid pressure in the first working chamber is above the second specified fluid pressure;
the second specified fluid pressure being greater than the first specified fluid pressure.

10. The shock absorber according to claim 9 further comprising:
a third single direction valve attached to the piston body, the third single direction valve actuating at a third specified fluid pressure in the second working chamber to allow fluid flow from the second working chamber directly to the first working chamber when fluid pressure within the second working chamber is above the third specified fluid pressure;
a fourth single direction valve attached to the piston body, the fourth single direction valve actuating at a fourth specified fluid pressure in the second working chamber to allow fluid flow from the second working chamber directly to the first working chamber when fluid pressure within the second working chamber is above the fourth specified fluid pressure;
the fourth fluid pressure being greater than the third fluid pressure.

11. The shock absorber according to claim 10 wherein the third and fourth single direction valves are adjustable valves.

12. The shock absorber according to claim 11 wherein the first and second single direction valves are adjustable valves.

13. The shock absorber according to claim 10 wherein the third and fourth single direction valves are actuated above the second specified pressure.

14. The shock absorber according to claim 13 wherein the first and second single direction valves are actuated above the first specified pressure.

15. Claim 12 depends on claim 9.

16. Claim 14 depends on claim 1.
